(19) United States
(12) Patent Application Publication
(10) Pub. No.: US 2020/0186617 A1
(43) Pub. Date: Jun. 11, 2020

(54) NETWORK CONTROL APPARATUS, NETWORK CONTROL METHOD AND NETWORK CONTROL SYSTEM

(71) Applicant: KABUSHIKI KAISHA TOSHIBA, Minato-ku (JP)

(72) Inventors: Hiroshi KAWAZOE, Kawasaki (JP); Daisuke Ajitomi, Setagaya (JP)

(73) Assignee: KABUSHIKI KAISHA TOSHIBA, Minato-ku (JP)

(21) Appl. No.: 16/557,216

(22) Filed: Aug. 30, 2019

(30) Foreign Application Priority Data
Dec. 10, 2018 (JP) 2018-230957

(51) Int. Cl. H04L 29/08

(52) U.S. Cl. CPC H04L 67/327; H04L 67/42; H04L 67/1034

(57) ABSTRACT

According to one embodiment, a network control apparatus is connected to a first relay server connected to devices, and a second relay server. The apparatus receives a stop request to stop of the first relay server, acquires identifier information of the devices, determines the second relay server as a new connecting destination corresponding to each of the devices, which is identified by the identifier information, based on the stop request, generates authentication information for each of the devices to connect the devices and the second relay server, and controls migration by transmitting a migration instruction for connection of the one or more devices to the second relay server and the authentication information to each of the devices.

### CROSS-REFERENCE TO RELATED APPLICATIONS

This application is based upon and claims the benefit of priority from Japanese Patent Application No. 2018-230957, filed Dec. 10, 2018, the entire contents of which are incorporated herein by reference.

### FIELD

Embodiments described herein relate generally to a network control apparatus, a network control method and a network control system.

### BACKGROUND

There is a system in which two-way communications are achieved between a server device and a client device by maintaining always-on connection between the server device and the client device and a system in which two-way communications are achieved between a plurality of client devices connected to a server device by causing the server device to function as a relay for the communications.

### BRIEF DESCRIPTION OF THE DRAWINGS

FIG. 1 is an illustration of a configuration example of a network control system including a network control apparatus according to a first embodiment.

FIG. 2 is a block diagram showing an example of a configuration of a control server, a broker server (#1), a broker server (#2), an arbitration server, a client (PC), an authentication information database and a broker server information database in the network control system according to the first embodiment.

FIG. 3 is a chart showing an example of a processing sequence executed until the client (PC) establishes always-on connection with the broker server (#1) based upon the configuration shown in FIG. 2 in the network control system according to the first embodiment.

FIG. 4 is a table showing an example of broker server information included in the broker server information database.

FIG. 5 is a table showing an example of authentication information registered in the authentication information database.

FIG. 6A is an illustration of the entire process of the control server to switch a connecting destination of the client (PC) from the broker server (#1) to the broker server (#2).

FIG. 6B is a chart showing an example of the process of the control server to switch a connecting destination of the client (PC) from the broker server (#1) to the broker server (#2).

FIG. 6C is a chart showing an example of a process of the client (PC) when the broker server (#1) that has received a migration instruction from a migration instruction communicator in the process of S616 shown in FIG. 6B migrates to the connected client (PC) 4.

FIG. 7 is a table showing an example of a client ID list.

FIG. 8 is a table showing an example of migration destination information.

FIG. 9 is a table showing an example in which an authentication information generator included in the control server updates the authentication information of the authentication information database.

FIG. 10 is a block diagram showing an example of a configuration of a network control system including the network control apparatus (control server) according to the first embodiment and also including an authentication server.

FIG. 11 is a chart showing an example of a process sequence executed until the client (PC) establishes an always-on connection with the broker server (#1) on the basis of the configuration shown in FIG. 10 in the network control system including the control server according to the first embodiment.

FIG. 12 is a block diagram showing an example of a configuration of a network control system including a network control apparatus (control server) according to a second embodiment.

FIG. 13 is a chart showing an example of a process sequence executed until the client (PC) establishes an always-on connection with the broker server (#1) on the basis of the configuration shown in FIG. 12 in the network control system including the control server according to the second embodiment.

FIG. 14 is a chart showing an example of a process of the control server to switch a connecting destination of the client (PC) from the broker server (#1) to the broker server (#2).

### DETAILED DESCRIPTION

Various embodiments will be described hereinafter with reference to the accompanying drawings.

In general, according to one embodiment, a network control apparatus is connected to a first relay server and a second relay server via the network. The first relay server is connected to one or more devices via the network. The network control apparatus includes a reception module, an identification information acquisition module, a migration destination determination module, a generator and a controller. The reception module is configured to receive a stop request to stop an operation of the first relay server. The identification information acquisition module is configured to acquire identifier information of the one or more devices connected to the first relay server. The migration destination determination module is configured to determine the second relay server as a new connecting destination corresponding to each of the one or more devices, which is identified by the acquired identifier information, based on the stop request. The generator is configured to generate authentication information for each of the one or more devices to connect the one or more devices and the second relay server. The controller configured to control migration by transmitting a migration instruction and the authentication information to each of the one or more devices. The migration instruction provides an instruction for connection of the one or more devices to the second relay server.

### First Embodiment

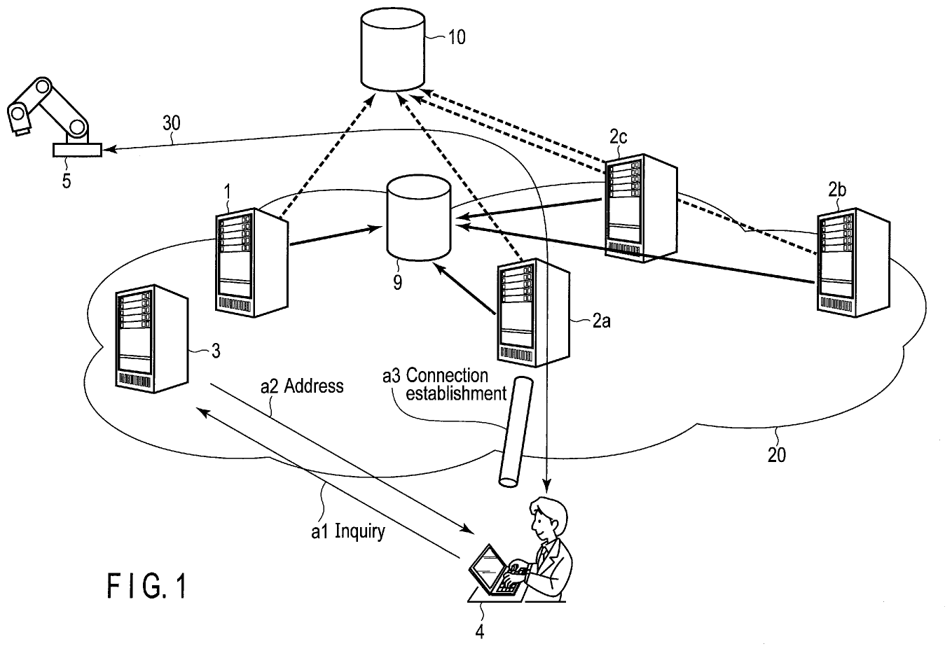

FIG. 1 is an illustration of a configuration example of a network control system including a network control apparatus according to a first embodiment.

The network control system includes a client (PC) 4, a client (device) 5 and a server group 20 on the cloud, and the client (PC) 4 can control the client (device) 5 via the server group 20.

The server group 20 on the cloud includes a broker server (#1) 2a, a broker server (#2) 2b and a broker server (#3) 2c which relay two-way communications between the client (PC) 4 and the client (device) 5, an arbitration server 3 that selects (arbitrates) a broker server for relaying communications between the client (PC) 4 and the client (device) 5 from among the broker servers and allocates the client (PC) 4 and the client (device) 5 to the selected broker server, a network control apparatus 1 that reallocates the client (PC) 4 and the client (device) 5 to another broker server (rearbitrates another broker server) when the broker server that relays communications between the client (PC) 4 and the client (device) 5 cannot be used temporarily, an authentication information database 9, and a broker server information database 10. The network control apparatus 1 is also referred to as a control server 1. The network control apparatus 1 will be described below as the control server 1.

In the example of FIG. 1, the server group 20 on the cloud includes three broker servers of the broker server (#1) 2a, broker server (#2) 2b and broker server (#3) 2c. In this example, furthermore, the client (PC) 4 and the client (device) 5 perform a two-way communications by relaying the broker server (#2) 2b. In addition to the client (PC) 4 and the client (device) 5, any number of devices can be connected to the broker servers.

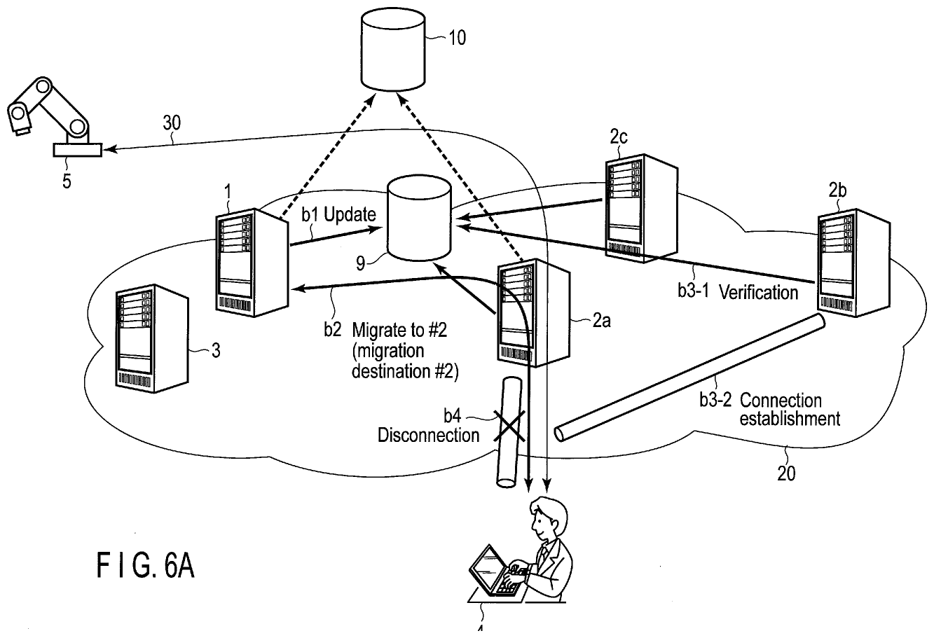

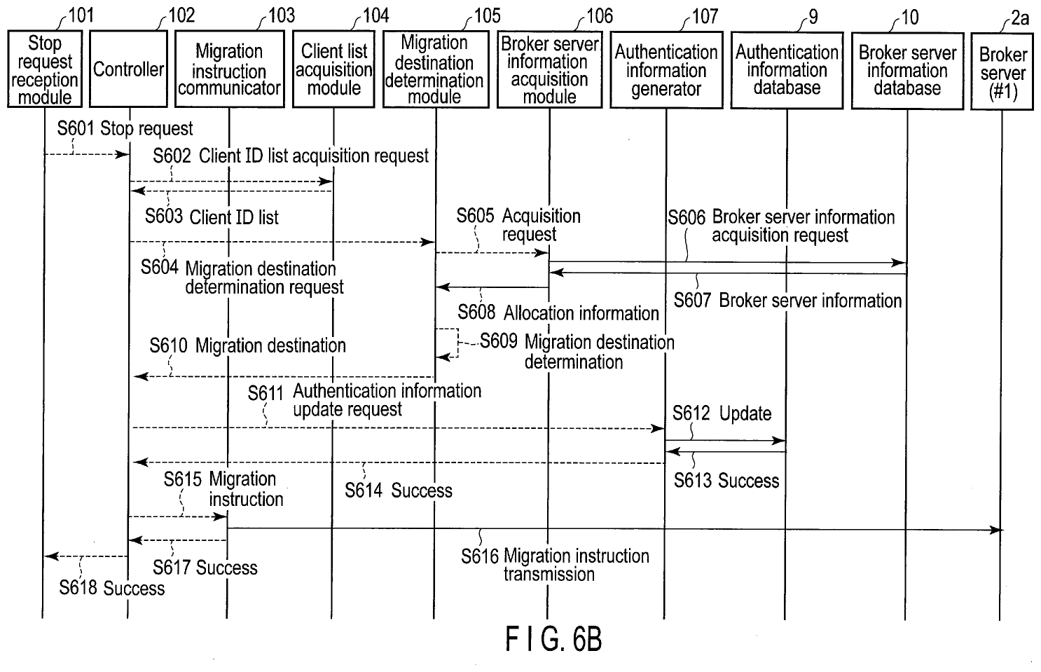

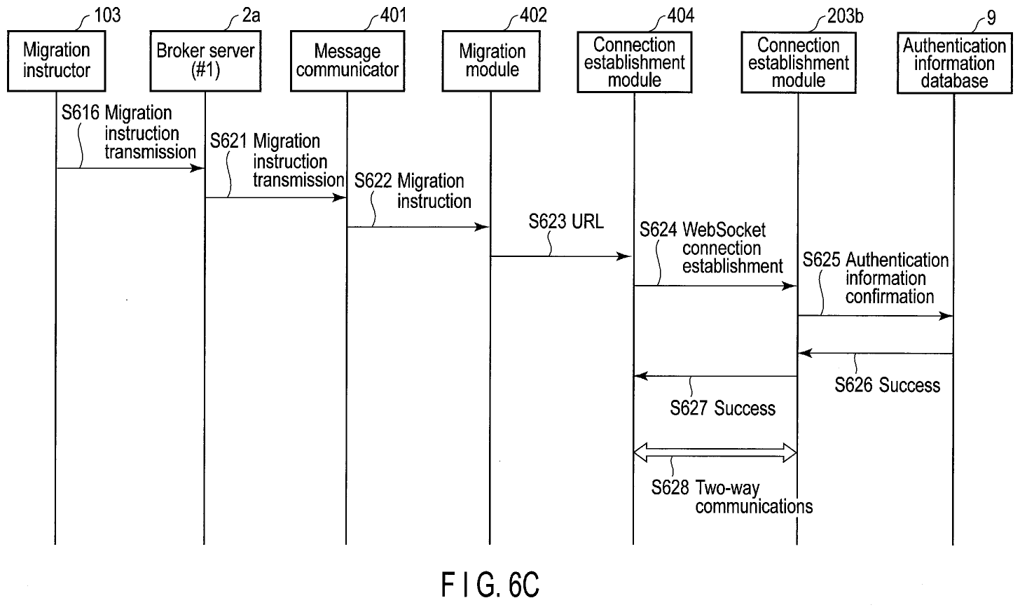

The control server 1 is a server that performs, when a broker server that relays communications between the client (PC) 4 and the client (device) 5 cannot temporarily be used because of, e.g., software updating, a process to allocate the client (PC) 4 and the client (device) 5 to another broker server. The process of the control server 1 will be described with reference to FIGS. 6A, 6B and 6C.

The broker server (#1) 2a, broker server (#2) 2b and broker server (#3) 2c are relay servers for performing always-on-connection two-way communications between the client (PC) 4 and the client (device) 5.

The arbitration server 3 is a server that allocates, when the always-on-connection two-way communications are started between the client (PC) 4 and the client (device) 5, a broker server for relaying the communications between the client (PC) 4 and the client (device) 5 from among the broker server (#1) 2a, broker server (#2) 2b and broker server (#3) 2c. In the example of FIG. 1, the arbitration server 3 allocates (arbitrates) the broker server (#1) 2a as a broker server for relaying communications between the client (PC) 4 and the client (device) 5.

The client (PC) 4 is a personal computer (PC) that communicates with the client (device) 5 via the broker server (#1) 2a allocated (arbitrated) by the arbitration server 3 to control the operation of the client (device) 5.

The client (device) 5 is a device that is controlled by the client (PC) 4. The client (device) 5 transmits a notification of the status of an operation controlled by the client (PC) 4 and a notification of the completion of the operation to the client (PC) 4 via the broker server (#1) 2a.

The authentication information database 9 registers information of the broker server allocated (arbitrated) as a server for relaying communications between the client (PC) 4 and the client (device) 5 by the control server 1 or the arbitration server 3.

The broker server information database 10 stores information of the number of current connections between the client (PC) 4 and client (device) 5 and the broker server (#1) 2a, broker server (#2) 2b and broker server (#3) 2c, which are managed by the arbitration server 3, and the upper limit of the number of connections, information of the URL by which the client (PC) 4 and client (device) 5 gain access to the broker server (#1) 2a, broker server (#2) 2b and broker server (#3) 2c, and the like. The stored information is called broker server information. Note that the protocol under which the broker server (#1) 2a, broker server (#2) 2b and broker server (#3) 2c are always connected to the client (PC) 4 and client (device) 5 is, for example, WebSocket.

In the example of FIG. 1, the client (PC) 4 and the client (device) 5 are always connected via a broker server. For example, the client (PC) 4 may be always connected to a WEB server via a broker server.

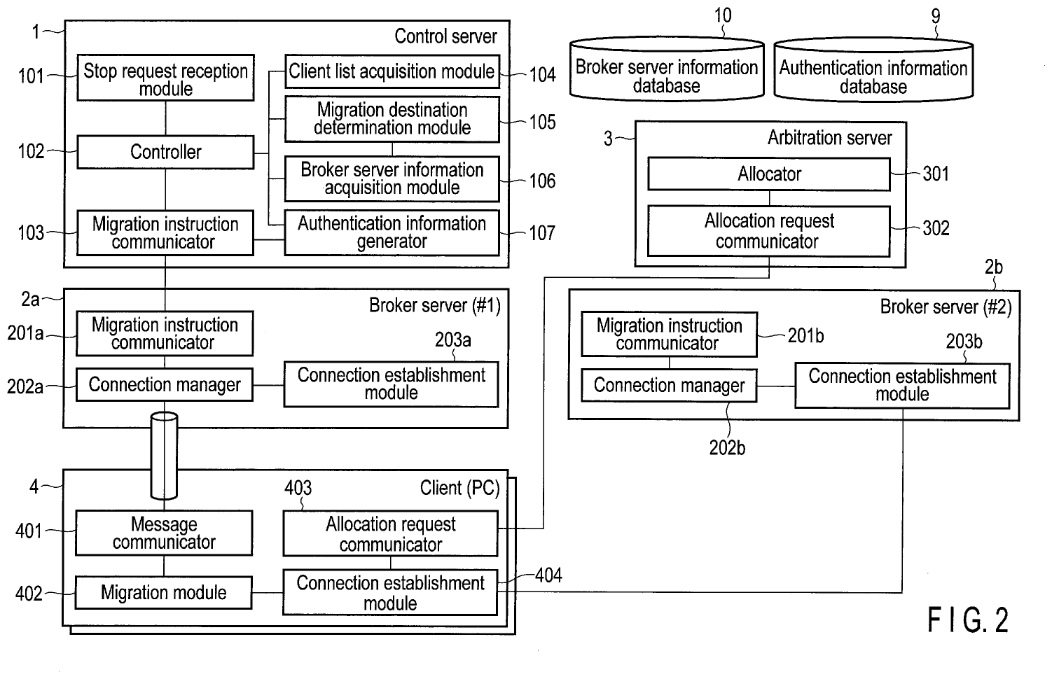

FIG. 2 is a block diagram showing an example of a configuration of the control server 1, broker server (#1) 2a, broker server (#2) 2b, arbitration server 3, client (PC) 4, authentication information database 9 and broker server information database 10 in the network control system according to the first embodiment.

The control server 1 includes a stop request reception module 101, a controller 102, a migration instruction communicator 103, a client list acquisition module 104, a migration destination determination module 105, a broker server information acquisition module 106 and an authentication information generator 107.

The arbitration server 3 includes an allocator 301 and an allocation request communicator 302.

The broker server (#1) 2a includes a migration instruction communicator 201a, a connection manager 202a and a connection establishment module 203a.

Similarly, the broker server (#2) 2b includes a migration instruction communicator 201b, a connection manager 202b and a connection establishment module 203b.

The client (PC) 4 includes a message communicator 401, a migration module 402, an allocation request communicator 403 and a connection establishment module 404.

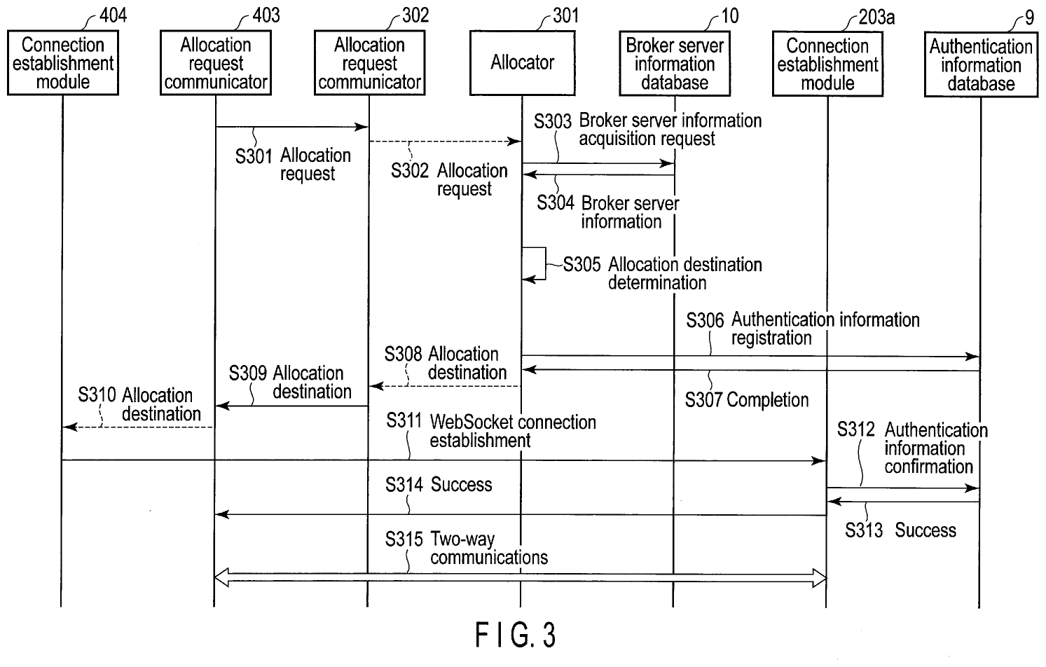

FIG. 3 is a chart showing an example of a processing sequence executed until the client (PC) 4 establishes always-on connection with the broker server (#1) 2a based upon the configuration shown in FIG. 2 in the network control system according to the first embodiment.

The client (PC) 4 starts a process to establish always-on connection with a broker server, for example, when power is turned on. This process may be started, for example, when the user of the client (PC) 4 gives an instruction.

In order to establish always-on connection with a broker server, the allocation request communicator 403 of the client (PC) 4 transmits an allocation request including an identifier for identifying the client itself (referred to as a client ID) to the allocation request communicator 302 of the arbitration server 3 via the network (S301). The client ID included in the allocation request by the allocation request communicator 403 of the Client (PC) 4 will be defined as “00001.”

Upon receiving the allocation request (S301), the allocation request communicator 302 of the arbitration server 3 notifies the allocator 301 of it (S302).

Upon receiving the notification, the allocator 301 transmits a broker server information acquisition request to the broker server information database 10 in order to acquire broker server information that is information such as an operating state of the broker server currently in operation (S303), thus obtaining broker server information (S304).

The allocator 301 of arbitration server 3, that acquired the broker server information (S304) confirms the contents of the broker server information and determines an allocation destination broker server from the managed broker servers by an optional method (S305).

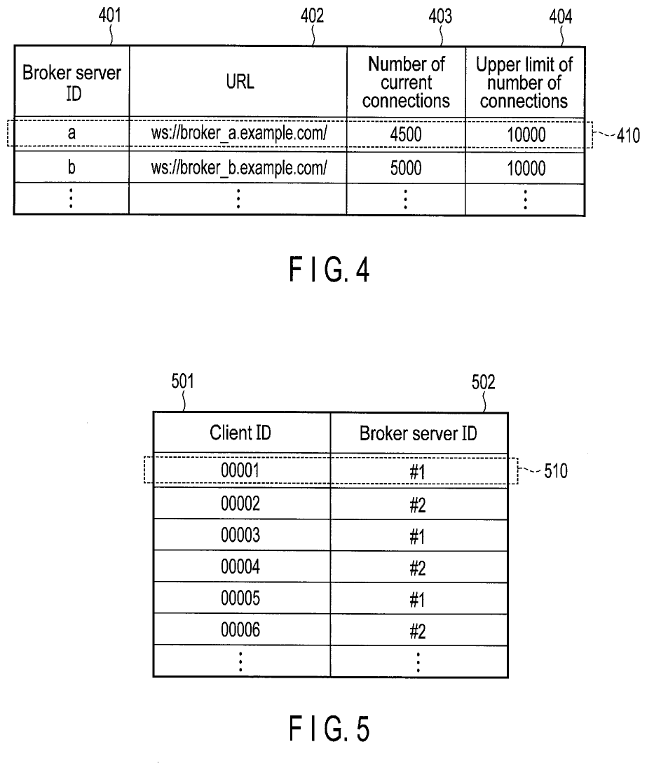

For example, the allocator 301 may determine a broker server whose use rate is low in the current state, from the broker server (#1) 2a, broker server (#2) 2b and broker server (#3) 2c as an allocation destination broker server and may determine a broker server whose connection number is small as an allocation destination broker server. The allocator 301 may also determine an allocation destination broker server such that the number of connections of the broker server (#1) 2a, the number of connections of the broker server (#2) 2b and the number of connections of the broker server (#3) 2c are equal to one another. Assume in the example of FIG. 3 that the allocator 301 has determined the broker server (#1) 2a as an allocation destination broker server of the client (PC) 4. An example of the broker information is shown in FIG. 4.

When the allocator 301 has determined the allocation destination broker server of the client (PC) 4, the allocator 301 registers authentication information in the authentication information database 9 (S306). The authentication information includes a pair of information items of the client ID of the client (PC) 4 and the ID (broker server ID) of the allocation destination broker server ID. An example of the authentication information registered in the authentication information database 9 is shown in FIG. 5.

When the allocator 301 completes registering the authentication information (S307), the allocator 301 notifies the allocation request communicator 403 of the client (PC) 4 (S309) of the URL of the broker server (#1) 2a, which is the allocation destination broker server, through the allocation request communicator 302 (S308).

Upon receiving a notification including the URL from the allocation request communicator 302 of the arbitration server 3 (S309), the allocation request communicator 403 of the client (PC) 4 notifies the connection establishment module 404 of the received URL of the allocation destination broker server (S310).

Upon receiving the notification (S310), the connection establishment module 404 performs a process to establish a connection with the broker server (#1) 2a based upon the received URL information (S311). The establishment of connection between the connection establishment module 404 and the broker server (#1) 2a is, for example, establishment of WebSocket connection.

The connection establishment module 404 gains access to the received URL to make a request for establishment of, e.g., WebSocket connection to the broker server (#1) 2a (S311). This connection establishment request includes the client ID of the client (PC) 4.

Upon receiving the establishment request (S311), the connection establishment module 203a of the broker server (#1) 2a inquires the authentication information database 9 (S312) to confirm whether a pair of information items of authentication information including the client ID of the client (PC) 4 representing that the allocation destination broker server of the client (PC) 4 is the broker server (#1) 2a and the broker server ID of the broker server (#1) 2a is registered (S312).

When the connection establishment module 203a has confirmed that the authentication information is registered in the authentication information database (S313), the connection establishment module 203a establishes, for example, the WebSocket connection to the client (PC) 4 and notifies the connection establishment module 404 of the client (PC) 4 of the completion of the connection establishment (S314).

If, for example, the WebSocket connection is maintained between the connection establishment module 404 and the broker server (#1) 2a, two-way communications can be carried out between the client (PC) 4 and the broker server (#1) 2a (S315).

FIG. 4 shows an example of the broker server information included in the broker server information database 10.

The broker server information includes information of a broker server ID 401, a URL 402 for gaining access to a broker server, the number of clients 403 currently connected to a broker server, and the upper limit of clients 404 connectable to a broker server. In FIG. 4, reference numeral 410 indicates that when the broker server ID is a, the URL for access to the broker server is ws://broker_a.example.com/, the number of clients currently connected to the broker server is 4500, and the upper limit of clients connectable to the broker server is 10000.

As described above, the broker server information includes information about the number of clients currently connected to a broker server. If, therefore, the allocator 301 refers to the broker information in order to determine an allocation destination broker server, the use rate that corresponds to the ratio of the number of clients currently connected to the broker server to the upper limit of clients connectable to the broker server can be used.

FIG. 5 shows an example of the authentication information registered in the authentication information database 9. The authentication information includes a client ID 501 representing the ID of a client such as the client (PC) 4 and the client (device) 5 and a broker server ID 502 representing the ID of a broker server connected to a client such as the client (PC) 4 and the client (device) 5. In FIG. 5, reference numeral 510 indicates that the client whose client ID is “00001” is connected to the broker server whose broker serve ID is “#1.”

As has been described above, the broker server may become unavailable temporarily because of software update, scale-in and the like. When the broker server (#1) 2a becomes unavailable temporarily unavailable in the client (PC) 4 and the broker server (#1) 2a which have established the WebSocket connection through, for example, the procedure described with reference to FIG. 3, the client (PC) 4 need to be allocated again to a new broker server selected from the broker Server (#2) 2b and the broker server (#3) 2c.

Therefore, the network control apparatus 1 (control server 1) according to the first embodiment makes it possible to perform a process of allocating a new broker server to the client (PC) 4, while avoiding a high load of the arbitration server 3, when the broker server (#1) 2a cannot be temporarily used.

Below is a description of a process of allocating a new broker server to the client (PC) 4 by the control server 1.

FIG. 6A is an illustration of the entire process of the control server 1 to switch a connecting destination of the client (PC) 4 from the broker server (#1) 2a to the broker server (#2) 2b.

In order to switch the connecting destination of the client (PC) 4 from the broker server (#1) 2a to the broker server (#2) 2b, the control server 1 performs a process of:

(1) determining a broker server (broker server (#2) 2b) of a migration destination of the client (PC) 4 and updating the authentication information database; and

(2) instructing the client (PC) 4 to migrate to the broker Server (#2) 2b through the broker server (#1) 2a to which the client (PC) 4 is connected.

After that, the client (PC) 4 that has been instructed to migrate performs the following process to establish a connection to the broker server (#2) 2b that is the migration destination.

(3) The client (PC) 4 requests the broker server (#2) 2b to establish a connection to the broker server (#2) 2b.

(3-1) The broker server (#2) 2b that has received the request for connection establishment inquires the authentication information database 9 to verify whether the request is valid.

(3-2) When the broker server (#2) 2b verifies that the request is valid, the broker server (#2) 2b completes establishing the connection to the client (PC) 4.

FIG. 6B is a chart showing an example of the process of the control server 1 to switch a connecting destination of the client (PC) 4 from the broker server (#1) 2a to the broker server (#2) 2b.

When the control server 1 is instructed to perform a process of allocating a new broker server by, for example, maintenance personnel (when the control server 1 receives the instruction from the maintenance personnel), the control server 1 starts a process of switching the connecting destination of the client (PC) 4 from the broker server (#1) 2a to the broker server (#2) 2b.

The maintenance personnel inputs the broker server ID of the broker server (#1) 2a that is a target to be stopped to the stop request reception module 101 of the control server 1 and requests the stop request reception module 101 to stop the broker server (#1) 2a.

Upon receiving the stop request from the stop request reception module 101 (S601), the controller 102 notifies the client list acquisition module 104 of the broker server ID of the broker server (#1) 2a to make a request to acquire a client ID list (S602).

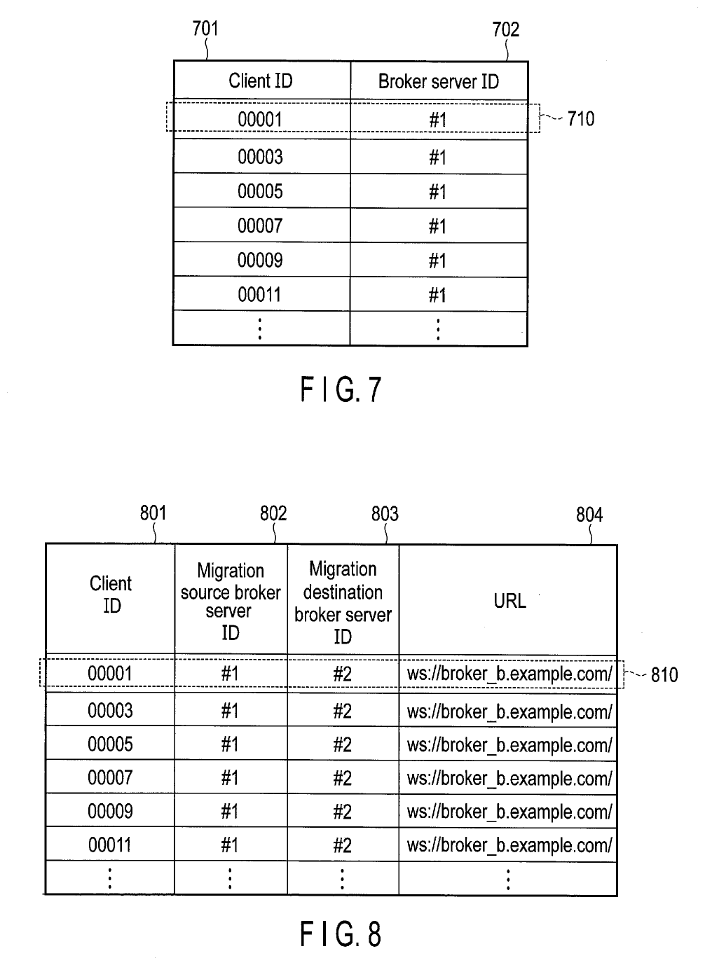

The client list acquisition module 104 may inquire, for example, the broker server (#1) 2a that is connected to the client (PC) 4 to acquire a client ID list. Alternatively, the client list acquisition module 104 may inquire the authentication information database 9 to acquire authentication information and generate a client ID list. FIG. 7 shows an example of the client ID list acquired by the controller 102.

When the client list acquisition module 104 acquires the client ID list, the client list acquisition module 104 transmits the acquired client ID list to the controller 102 (S603).

When the controller 102 receives the client ID list (S603), the controller 102 notifies the migration destination determination module 105 of the acquired client ID list (S604).

Upon receiving the notification (S604), the migration destination determination module 105 switches the WebSocket connection in which a connection is established between the broker server (#1) 2a and all the clients included in the client ID list, to a new WebSocket connection to determine a migration destination broker server.

Below is a description of an example of a process of switching a WebSocket connection in which a connection between the client (PC) 4 included in the client ID list and the broker server (#1) 2a is established to a WebSocket connection between the client (PC) 4 and a migration destination broker server.

The migration destination determination module 105 transmits a broker server information acquisition request to the broker server information acquisition module 106 (S605).

Upon receiving the acquisition request (S605), the broker server information acquisition module 106 transmits the broker server information acquisition request to the broker server information database 10 (S606) to acquire the broker server information (S607).

Upon receiving the broker server information (S607), the broker server information acquisition module 106 transmits the received broker server information to the migration destination determination module 105 (S608).

Upon receiving the broker server information (S608), the migration destination determination module 105 confirms the contents of the broker server information and determines a migration destination broker server from the managed broker servers by an optional method (S609).

To determine a migration destination broker server, the migration destination determination module 105 may determine, for example, a broker server whose use rate is low in the current state, from the broker server (#1) 2a, broker server (#2) 2b and broker server (#3) 2c as an allocation destination broker server.

The migration destination determination module 105 notifies the controller 102 of the determined migration destination information (S610). The contents of the migration destination information of which the migration destination determination module 105 notifies the controller 102 include, for example, a client ID, a broker server ID of a broker server (a migration source broker server) to which the client of the client ID is currently connected, a migration destination broker server ID, and the URL of the migration destination broker server. An example of the migration destination information of which the migration destination determination module 105 notifies the controller 102, is shown in FIG. 8.

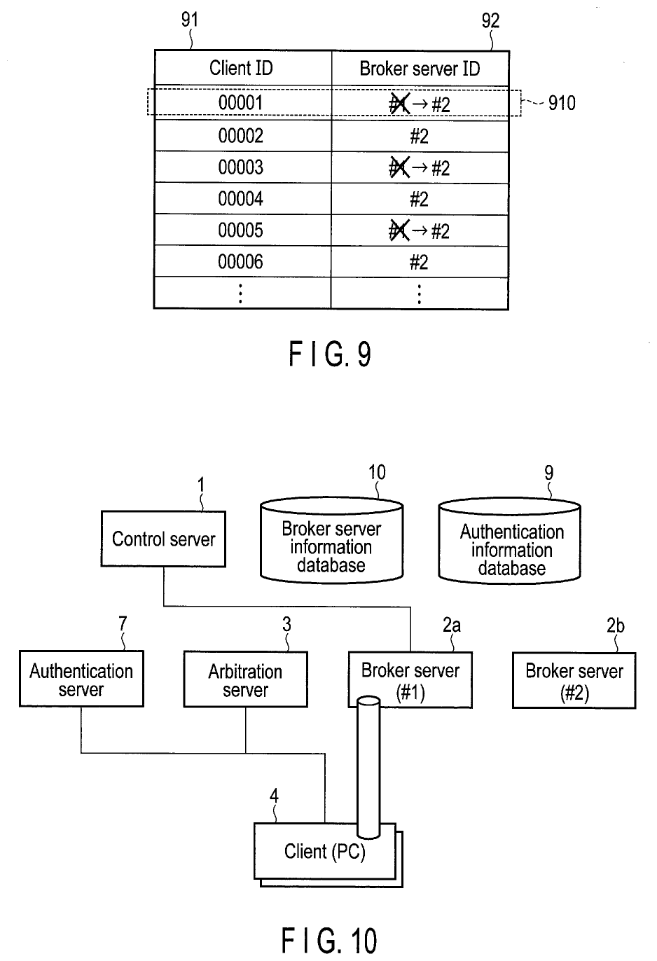

The controller 102 transmits the received migration destination information (S610) to the authentication information generator 107 (S611). Upon receiving the migration destination information (S611), the authentication information generator 107 updates the authentication information database 9 based on the received migration destination information (S612). The authentication information of the authentication information database 9 updated by the authentication information generator 107 is shown in FIG. 9.

When the authentication information generator 107 completes updating the authentication information (S613), the authentication information generator 107 notifies the controller 102 of the completion (S614).

Upon receiving the notification, the controller 102 transmits a migration instruction to instruct the migration instruction communicator 103 to cause the client (PC) 4 to migrate to the migration destination broker server described in the migration destination information received in S610 (S615).

Upon receiving the migration instruction, the migration instruction communicator 103 sends a migration instruction including information of the migration destination broker server to the broker server (#1) 2a that is a migration source broker server (S616). The information of the migration destination broker server includes the URL to which the migration destination broker server gains access.

When the migration instruction communicator 103 completes sending the migration instruction (S616), the migration instruction communicator 103 transmits a notification of the completion to the controller 102 (S617).

Upon receiving the notification of the completion (S617), the controller 102 notifies the stop request reception module 101 of the completion (S618) and terminates the migration process.

Upon receiving the notification of the completion (S618), the stop request reception module 101 may display the completion of the migration on a display (not shown) such that, for example, the maintenance personnel can recognize it.

FIG. 6B shows an example where the maintenance personnel gives (inputs) an instruction to perform a process of allocating a new broker server. For example, the controller 102 may determine a certain condition and start a migration process. The certain condition may include, for example, specific time and a congestion level of each broker server.

FIG. 6C is a chart showing an example of a process of the client (PC) 4 when the broker server (#1) 2a that has received a migration instruction from the migration instruction communicator 103 in the process of S616 shown in FIG. 6B migrates to the connected client (PC) 4.

When the message communicator 401 of the client (PC) 4 receives the migration instruction, which was sent from the migration instruction communicator 103 of the control server 1 (S616), through, for example, the WebSocket connection that is established between the message communicator 401 and the broker server (#1) 2a (S621), the message communicator 401 notifies the migration module 402 of the received migration instruction (S622).

Upon receiving the migration instruction from the message communicator 401 (S622), the migration module 402 extracts the URL of the broker server (#2) 2b that is a migration destination broker server included in the migration instruction, and sends information of the extracted URL to the connection establishment module 404 (S623).

The connection establishment module 404 gains access to the received URL (S623) to make a request for establishment of, e.g., WebSocket connection to the broker server (#2) 2b that is a migration destination broker server (S624). The establishment request made by the connection establishment module 404 includes the client ID of the client (PC) 4 that is a request source of the establishment request.

Upon receiving the request for connection establishment (S624), the connection establishment module 203b of the broker server (#2) 2b inquires of the authentication information database 9 (S625) whether authentication information including a pair of information items of the ID of the broker server (#2) 2b and the client ID of the client (PC) 4 indicating that the migration destination broker server of the client (PC) 4 is the broker server (#2) 2b is registered.

When the connection establishment module 203b confirms that the authentication information including the paired information items is registered in the authentication information database 9 (S626), the connection establishment module 203b establishes, e.g., WebSocket connection to the client (PC) 4 and notifies the connection establishment module 404 of the client (PC) 4 of the completion of the connection establishment (S627). Thus, the broker server (#2) 2b determines that the connection request has been transmitted from the authorized client (PC) 4 and maintains, e.g., the WebSocket connection established between the broker server (#2) 2b and the client (PC) 4 to allow two-way communications between the broker server (#2) 2b and the client (PC) 4 (S628).

The above example has been described with an emphasis on the case where the client (PC) 4 causes the connected broker server (#1) 2a to migrate to the broker server (#2) 2b. The controller 102 of the control server 1 performs a similar process for all clients included in the client ID list acquired in S603 to cause the connected broker server (#1) 2a to migrate to another broker server.

When specific two clients included in the client ID list are communicating with each other via the broker server (#1) 2a, it is desirable that the controller 102 of the control server 1 should cause the two clients to migrate to the same broker server. For example, the client (PC) 4 shown in FIG. 1 performs two-way communications with the client (device) 5 via the broker server (#1) 2a. In this case, it is desirable that the controller 102 of the control server 1 should cause, e.g., the broker server (#1) 2a relayed by the client (PC) 4 and the client (device) 5 to migrate to the same broker server, e.g., the broker server (#2) 2b.

As described above, the network control apparatus 1 (control server 1) according to the first embodiment makes it possible to perform a process of allocating a new broker server to the client (PC) 4, while avoiding a high load of the arbitration server 3, when the broker server stops temporarily. Particularly, the control server 1 can avoid a high load of the arbitration server because the control server 1 directly instructs each of the broker servers connected to the broker server that stops temporarily to migrate to a new broker server.

The network control system including the network control apparatus according to the first embodiment may include an authentication server.

FIG. 7 is a table showing an example of the client ID list. The client ID list includes a client ID and a broker server ID. In the example of FIG. 7, the client IDs connected to the broker server (#1) 2a whose broker server ID is #1 are listed. In FIG. 7, reference numeral 710 indicates that the client whose client ID is 00001 is connected to the broker server (#1) 2a.

FIG. 8 is a table showing an example of the migration destination information. The migration destination information includes a client ID 801, a broker server ID 802 of a broker server (migration source broker server) to which a client with a client ID is currently connected, a broker server ID 803 of the migration destination broker server, and a URL 804 of the migration destination broker server. In FIG. 8, reference numeral 810 indicates that the broker server ID of a broker server to which a client whose client ID is 00001 is currently connected is #1, the broker server ID of a migration destination broker server is #2, and the URL of the migration destination broker server is ws://broker_b.example.com/.

FIG. 9 shows an example in which the authentication information generator 107 included in the control server 1 updates the authentication information of the authentication information database 9. As indicated by reference numeral 910 in FIG. 9, a client whose client ID is “00001” migrates from a connecting destination broker server whose broker server ID is #1 to a broker server whose broker server ID is #2.

The network control system including the network control apparatus 1 (control server 1) according to the first embodiment may be configured in another manner.

FIG. 10 is a block diagram showing an example of a configuration of a network control system including the network control apparatus 1 (control server 1) according to the first embodiment and also including an authentication server 7.

The network control system including the network control apparatus 1 according to the first embodiment may include the control server 1, broker server (#1) 2a, broker server (#2) 2b, arbitration server 3, client (PC) 4, authentication server 7, authentication information database 9 and broker server information database 10.

The authentication server 7 performs a login process when the client (PC) 4 starts to gain access to the network control system including the network control apparatus 1 (control server 1) according to the first embodiment.

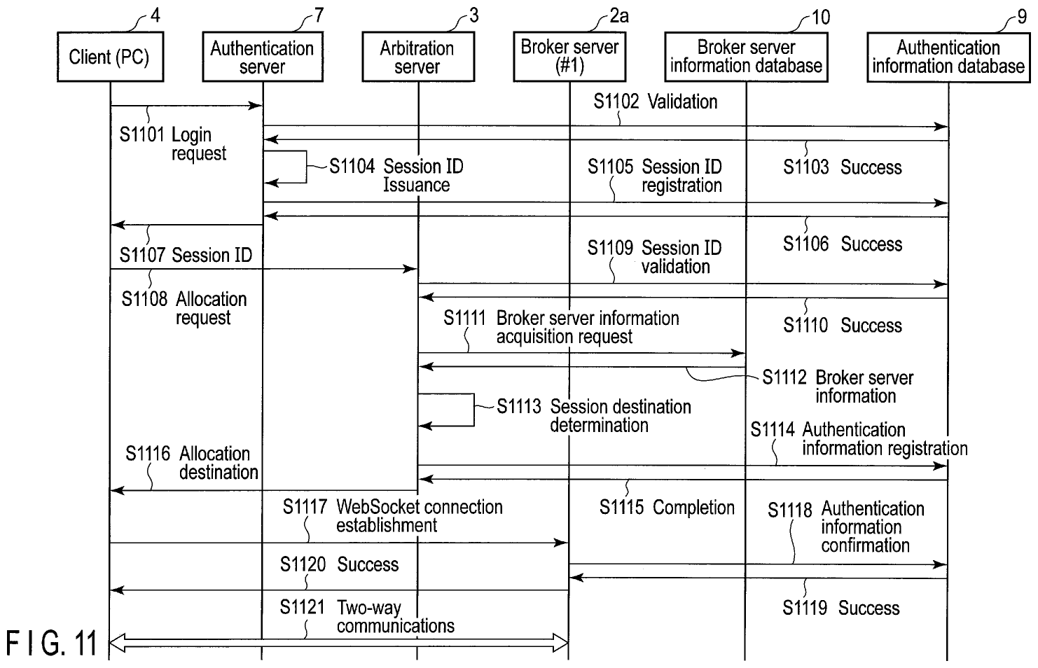

FIG. 11 is a chart showing an example of a process sequence executed until the client (PC) 4 establishes an always-on connection with the broker server (#1) 2a on the basis of the configuration shown in FIG. 10 in the network control system including the control server 1 according to the first embodiment.

When the user of the client (PC) 4 enters his or her own user ID and password to start to gain access to the network control system including the control server 1 according to the first embodiment, the client (PC) 4 sends a login request including the entered user ID and password to the authentication server 7 (S1101).

Upon receiving the login request including the user ID and password from the client (PC) 4 (S1101), the authentication server 7 inquires of the authentication information database (S1102) whether the received user ID and password are valid.

When the login request in S1101 is determined as one from an authorized user as a result of the inquiry (S1103), the authentication server 7 issues a new session ID to start a session of the client (PC) 4 (S1104). The authentication server 7 registers the issued session ID in the authentication information database 9 (S1105). When the registration is completed (S1106), the authentication server 7 notifies the client (PC) 4 of the issued session ID (S1107) and terminates the login process.

Like the process of achieving the two-way communications by establishing a WebSocket connection between the client (PC) 4 and the broker server (#1) 2a shown in FIG. 3, a process of achieving two-way communications between the client (PC) 4 and the broker server (#1) 2a is performed.

The client (PC) 4 transmits an allocation request including the session ID received in S1107 to the arbitration server 3 via the network (S1108).

Upon receiving the allocation request (S1108), the arbitration server 3 inquires of the authentication information database 9 whether the allocation request includes a session ID (S1109).

If the allocation request includes a session ID, the arbitration server 3 determines that the client (PC) 4 is logging in and continues a process for achieving two-way communications.

Then, the arbitration server 3 transmits a broker server information acquisition request to the broker server information database 10 (S1111) to acquire broker server information indicating, e.g., an operating state of the currently operating broker server (S1112).

When the arbitration server 3 acquires the broker server information (S1112), the arbitration server 3 confirms the contents of the broker server information and determines an allocation destination broker server from the managed broker servers by an optional method (S1113).

When the arbitration server 3 determines an allocation destination broker server of the client (PC) (S1113), the arbitration server 3 registers authentication information in the authentication information database 9 (S1114).

When the arbitration server 3 completes registering the authentication information (S1115), the arbitration server 3 notifies the client (PC) 4 of the URL of the broker server (#1) 2a that is an allocation destination broker server (S1116).

Upon receiving a notification including the URL of the allocation destination broker server from the arbitration server 3 (S1116), the client (PC) 4 performs a process for establishment of connection to the broker server (#1) 2a based upon the received URL of the allocation destination broker server (S1117). This connection establishment is establishment of, e.g., WebSocket connection.

The client (PC) 4 gains access to the received URL to make a request for establishment of, e.g., WebSocket connection (S1117).

Upon receiving the establishment request (S1117), the broker server (#1) 2a inquires of the authentication information database 9 (S1118) whether authentication information including a pair of information items of the client ID of the client (PC) 4 and the broker server ID of the broker server (#1) 2a, which indicates that the allocation destination broker server of the client (PC) 4 is the broker server (#1) 2a, is registered in the authentication information database (S1118).

When the broker server (#1) 2a determines that the authentication information is registered in the authentication information database (S1119), the broker server (#1) 2a establishes, e.g., WebSocket connection to the client (PC) 4 and notifies the client (PC) 4 of the completion of the connection establishment (S1120).

After that, two-way communications can be carried out between the client (PC) 4 and the broker server (#1) 2a by maintaining, e.g., the WebSocket connection between the connection establishment module 404 of the client (PC) 4 and the broker server (#1) 2a (S1121).

When the broker server (#1) 2a is temporarily unavailable, the same process as shown in FIGS. 6B and 6C is performed even in the network control system including the network control apparatus according to the first embodiment including the authentication server 7.

### Second Embodiment

Furthermore, the network control apparatus 1 (control server 1) may control an authentication token.

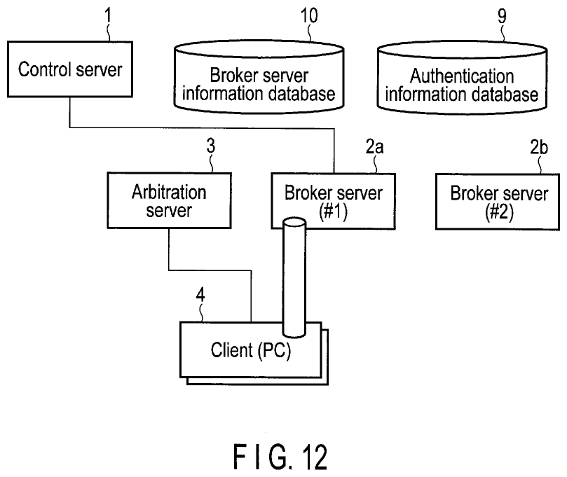

FIG. 12 is a block diagram showing an example of a configuration of a network control system including a network control apparatus 1 (control server 1) according to a second embodiment.

The network control system may include a control server 1 according to the second embodiment, a broker server (#1) 2a, a broker server (#2) 2b, an arbitration server 3, a client (PC) 4, an authentication information database 9 and a broker server information database 10.

The control server 1 has a function of generating an authentication token. When a connecting destination broker server of the client (PC) 4 is switched under the control of the control server 1, the generated authentication token becomes authentication information to be sent to the broker server (#2) 2b to establish, e.g., WebSocket connection to the client (PC) 4 and a new connecting destination, e.g., the broker server (#2) 2b.

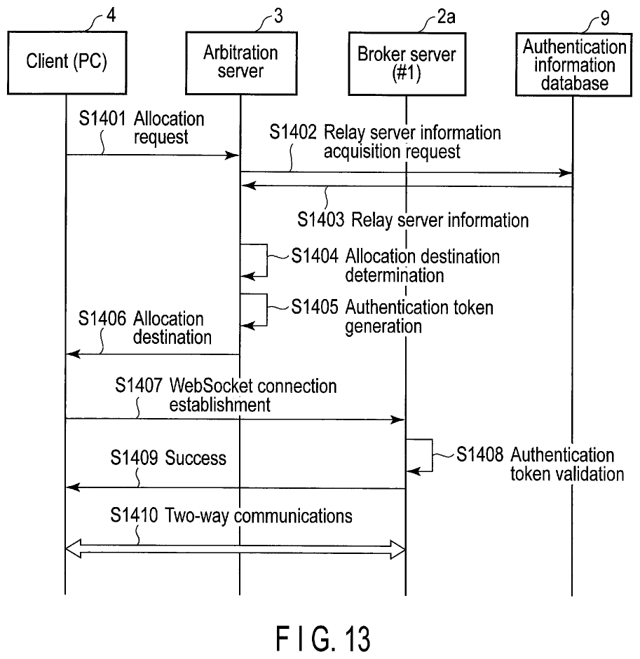

FIG. 13 is a chart showing an example of a process sequence executed until the client (PC) 4 establishes an always-on connection with the broker server (#1) 2a on the basis of the configuration shown in FIG. 12 in the network control system including the control server 1 according to the second embodiment.

The client (PC) 4 starts a process of establishing an always-on connection with the broker server, for example, when power is turned on. This process may be started, for example, when the user of the client (PC) 4 gives an instruction.

In order to establish an always-on connection with the broker server, the client (PC) 4 transmits an allocation request including an identifier for identifying the client itself (referred to as a client ID) to the arbitration server 3 via the network (S1401).

Upon receiving the allocation request (S1401), the arbitration server 3 transmits a broker server information acquisition request to the broker server information database 10 (S1402) to acquire broker server information that is information about, e.g., the operating state of the currently operating broker server (S1403).

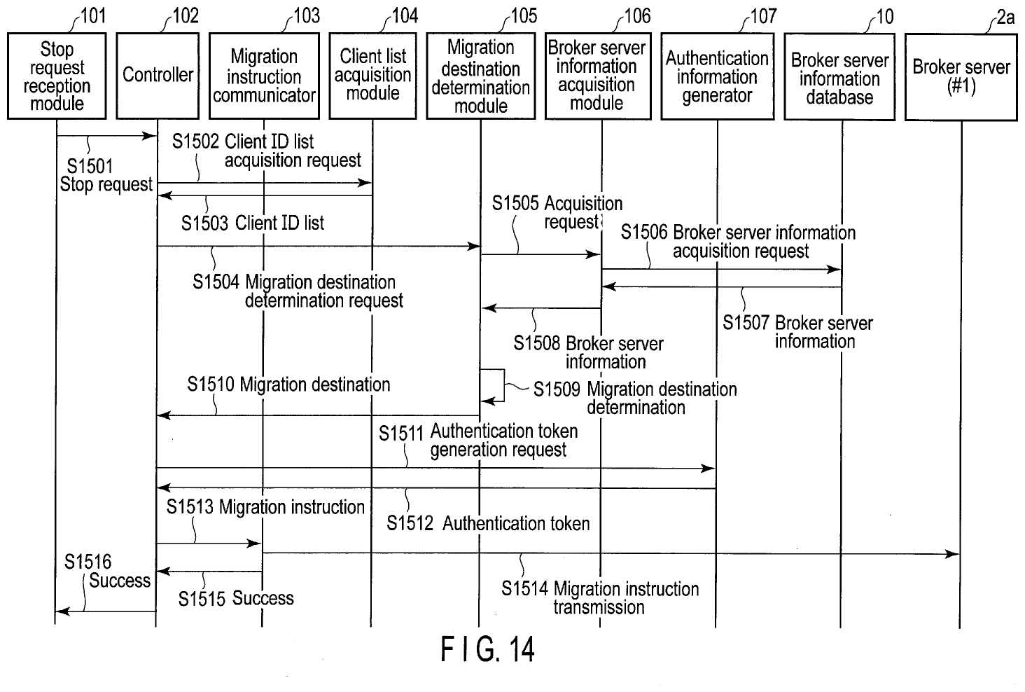

When the arbitration server 3 acquires the broker server information (S1403), the arbitration server 3 confirms the contents of the broker server information and determines an allocation destination broker server from the managed broker servers by an optional method (S1404). In the example of FIG. 14, it is assumed that the arbitration server 3 determines the broker server (#1) 2a as an allocation destination broker server of the client (PC) 4.

Furthermore, the arbitration server 3 generates an authentication token (S1405). The authentication token may be, for example, the client ID of the client (PC) 4, the broker server ID of the broker server (#1) 2a that is an allocation destination broker server determined in S1404, and a character string generated by encrypting a character string with the expiration date of the authentication token.

The arbitration server 3 notifies the client (PC) 4 of the generated authentication token and the URL of the broker server (#1) 2a that is an allocation destination broker server (S1406).

Upon receiving the notification, the client (PC) 4 performs a process of establishing a connection with the broker server (#1) 2a based on the URL information included in the notification (S1407). The establishment of connection between the client (PC) 4 and the broker server (#1) 2a is, for example, establishment of WebSocket connection.

The client PC4 gains access to the received URL to make a request to establish, for example, the WebSocket connection (S1407). This request includes an authentication token received in S1406.

Upon receiving the establishment request, the broker server (#1) 2a decrypts the authentication token to confirm the client ID of the client (PC) 4 and the broker server ID of the allocation destination, which are included in the authentication token, and the expiration date of the authentication token. More specifically, the broker server (#1) 2a confirms that the client ID of the client (PC) 4 that is a transmission source of the establishment request coincides with the client ID included in the authentication token, that the broker server ID of the broker server (#1) 2a coincides with the broker server ID included in the authentication token, and that the current time is before the expiration date and determines the client (PC) 4 as an authorized transmission source of the establishment request (S1408). Then, the broker server (#1) 2a establishes, for example, the WebSocket connection with the client (PC) 4 and notifies the client (PC) 4 of the completion of the connection establishment (S1409).

After that, if, for example, the WebSocket connection is maintained between the client (PC) 4 and the broker server (#1) 2a, two-way communications can be carried out between the client (PC) 4 and the broker server (#1) 2 (S1410).

As has been described, when the broker server may be unavailable temporarily because of software update, scale-in and the like, the client (PC) 4 needs to be allocated again to a new broker server of the broker server (#2) 2b and the broker server (#3) 2c.

FIG. 14 is a chart showing an example of a process of the control server 1 to switch a connecting destination of the client (PC) 4 from the broker server (#1) 2a to the broker server (#2) 2b.

When the control server 1 is instructed to perform a process of allocating a new broker server by, for example, maintenance personnel (when the control server 1 receives the instruction from the maintenance personnel), the control server 1 starts a process of switching the connecting destination of the client (PC) 4 from the broker server (#1) 2a to the broker server (#2) 2b.

The maintenance personnel inputs the broker server ID of the broker server (#1) 2a that is a target to be stopped to the stop request reception module 101 of the control server 1 and requests the stop request reception module 101 to stop the broker server (#1) 2a (S1501).

Upon receiving the stop request from the stop request reception module 101 (S1501), the controller 102 notifies the client list acquisition module 104 of the broker server ID of the broker server (#1) 2a to make a request to acquire a client ID list (S1502).

The client list acquisition module 104 may inquire, for example, the broker server (#1) 2a that is connected to the client (PC) 4 to acquire a client ID list. Alternatively, the client list acquisition module 104 may inquire the authentication information database 9 to acquire authentication information and generate a client ID list. FIG. 7 shows an example of the client ID list.

When the client list acquisition module 104 acquires the client ID list, the client list acquisition module 104 transmits the acquired client ID list to the controller 102 (S1503).

When the controller 102 receives the client ID list (S1503), the controller 102 notifies the migration destination determination module 105 of the acquired client ID list (S1504).

Upon receiving the notification (S1504), the migration destination determination module 105 determines a broker server to switch the WebSocket connection in which a connection is established between the broker server (#1) 2a and the client (PC) 4.

The migration destination determination module 105 transmits a broker server information acquisition request to the broker server information acquisition module 106 (S1505).

Upon receiving the acquisition request (S1505), the broker server information acquisition module 106 transmits the broker server information acquisition request to the broker server information database 10 (S1506) to acquire the broker server information (S1507).

The broker server information database 10 receives the broker server information acquisition request (S1506).

Upon receiving the broker server information acquisition request (S1506), the broker server information database 10 transmits the broker server information to the broker server information acquisition module 106 of the control server 1 (S1507).

Upon receiving the broker server information (S1507), the broker server information acquisition module 106 transmits the received broker server information to the migration destination determination module 105 (S1508).

Upon receiving the broker server information (S1508), the migration destination determination module 105 confirms the contents of the broker server information and determines a migration destination broker server from the managed broker servers by an optional method (S1509).

The migration destination determination module 105 notifies the controller 102 of the determined migration destination information (S1510).

The contents of the migration destination information of which the migration destination determination module 105 notifies the controller 102 include, for example, a client ID, a broker server ID of a migration source broker server, and a broker server ID of a migration destination broker server.

The controller 102 transmits the received migration destination information (S1510) to the authentication information generator 107 to request the authentication information generator 107 to generate an authentication token (S1511). Based on the received migration destination information, the authentication information generator 107 generates an authentication token and transmits it to the controller 102 (S1512). Like the authentication token generated in S1405, the authentication token may be, for example, the client ID of the client (PC) 4, the broker server ID of the broker server (#1) 2a that is an allocation destination broker server determined in S1509, and a character string generated by encrypting a character string with the expiration date of the authentication token.

Upon receiving the authentication token, the controller 102 transmits a migration instruction to instruct the migration instruction communicator 103 to cause the client (PC) 4 to migrate to the migration destination broker server described in the migration destination information received in S1510 (S1513).

Upon receiving the migration instruction, the migration instruction communicator 103 sends a migration instruction including information of the migration destination broker server to the broker server (#1) 2a that is a migration source broker server (S1514). The information of the migration destination broker server includes the URL to which the migration destination broker server gains access.

When the migration instruction communicator 103 completes sending the migration instruction (S1514), the migration instruction communicator 103 transmits a notification of the completion to the controller 102 (S1515).

Upon receiving the notification of the completion (S1515), the controller 102 notifies the stop request reception module 101 of the completion (S1516) and terminates the migration process.

Upon receiving the migration instruction from the migration instruction communicator 103 in the process of S1514 shown in FIG. 15, the broker server (#1) 2a performs a migration process for the client (PC) 4 connected to the broker server (#1) 2a, as in the processes of S616 and S623 shown in FIG. 6C. The client (PC) 4 which is requested to perform the migration process verifies the migration process using the authentication token to establish the WebSocket connection to the broker server (#2) 2b that is a migration destination broker server.

The above example has also been described with an emphasis on the case where the client (PC) 4 causes the connected broker server (#1) 2a to migrate to the broker server (#2) 2b as in the cases shown in FIGS. 6B and 6C. The controller 102 of the control server 1 performs a similar process for all clients included in the client ID list acquired in S1503 to cause the connected broker server (#1) 2a to migrate to another broker server.

As described above, the network control apparatus 1 (control server 1) according to the present embodiment may have a function of generating an authentication token. In this case, too, when the broker server stops temporarily, a new broker server can be allocated to the client (PC) 4 while avoiding a high load of the arbitration server 3.

As described above, various types of network control system including the network control apparatus (control server 1) according to the present embodiment makes it possible to perform a process of allocating a new broker server to the client (PC) 4, while avoiding a high load of the arbitration server 3, when the broker server stops temporarily.

In the foregoing descriptions, the control server 1 is achieved as a server other than the broker server 2 and the arbitration server 3; however, the control server 1 is not limited to the configuration described above. For example, some or all of the structural elements of the control server 1 may be included in the broker server or the arbitration server 3.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A network control apparatus connected to a first relay server and a second relay server via the network, the first relay server being connected to one or more devices via the network, the network control apparatus comprising:
a reception module configured to receive a stop request to stop an operation of the first relay server;
an identification information acquisition module configured to acquire identifier information of the one or more devices connected to the first relay server;
a migration destination determination module configured to determine the second relay server as a new connecting destination corresponding to each of the one or more devices, which is identified by the acquired identifier information, based on the stop request;
a generator configured to generate authentication information for each of the one or more devices to connect the one or more devices and the second relay server; and
a controller configured to control migration by transmitting a migration instruction and the authentication information to each of the one or more devices, the migration instruction providing an instruction for connection of the one or more devices to the second relay server.

2. The network control apparatus of claim 1, further comprising a relay server information acquisition module configured to acquire relay server information about an operating state of the relay server,
wherein the migration destination determination module is configured to determine the new connecting destination based on the relay server information acquired by the relay server information acquisition module.

3. The network control apparatus of claim 2, wherein the migration destination determination module is configured to determine the second relay server as a new connecting destination to which a first device and a second device are connected, the first device and the second device communicating with each other via the first relay server.

4. The network control apparatus of claim 1, wherein the controller is configured to register the authentication information in a relay server information database.

5. The network control apparatus of claim 1, wherein the controller is configured to instruct, with the migration instruction, the one or more devices to establish connection between the one or more devices and the second relay server using the authentication information, the one or more devices being to be transmitted the migration instruction and the authentication information.

6. A network control method of a network control apparatus connected to a first relay server and a second relay server via the network, the first relay server being connected to one or more devices via the network, the network control method comprising:
receiving a stop request to stop an operation of the first relay server;
acquiring identifier information of the one or more devices connected to the first relay server;
determining the second relay server as a new connecting destination corresponding to each of the one or more devices, which is identified by the acquired identifier information, based on the stop request;
generating authentication information for each of the one or more devices to connect the one or more devices and the second relay server; and
controlling migration by transmitting a migration instruction and the authentication information to each of the one or more devices, the migration instruction providing an instruction for connection of the one or more devices to the second relay server.

7. A non-transitory computer-readable storage medium having stored thereon a computer program which is executable by a computer, the computer program controlling the computer to execute functions of:
receiving a stop request to stop an operation of a first relay server;
acquiring identifier information of one or more devices connected to the first relay server;
determining a second relay server as a new connecting destination corresponding to each of the one or more devices, which is identified by the acquired identifier information, based on the stop request;
generating authentication information for each of the one or more devices to connect the one or more devices and the second relay server; and
controlling migration by transmitting a migration instruction and the authentication information to each of the one or more devices, the migration instruction providing an instruction for connection of the one or more devices to the second relay server.

8. A network control system comprising:
a first relay server connected to one or more devices via a network;
a second relay server; and
a network control apparatus, wherein
the first relay server and the second relay server is connected to the network control apparatus via the network, and
the network control apparatus comprises:
a reception module configured to receive a stop request to stop an operation of the first relay server;
an identification information acquisition module configured to acquire identifier information of the one or more devices connected to the first relay server;
a migration destination determination module configured to determine the second relay server as a new connecting destination corresponding to each of the one or more devices, which is identified by the acquired identifier information, based on the stop request;
a generator configured to generate authentication information for each of the one or more devices to connect the one or more devices and the second relay server; and
a controller configured to controls migration by transmitting a migration instruction and the authentication information to each of the one or more devices, the migration instruction providing an instruction for connection of the one or more devices to the second relay server, and
the one or more devices comprise a connection establishment module configured to establish connection of the one or more devices to the second relay server based on the migration instruction and the authentication information.

9. A network control apparatus connected to a plurality of relay servers via a network, the plurality of relay servers including a first relay server connected to one or more devices via the network, the network control apparatus comprising:
a reception module configured to receive a stop request to stop an operation of the first relay server;
an identification information acquisition module configured to acquire identifier information of the one or more devices connected to the first relay server;
a migration destination determination module configured to determine a new connecting destination corresponding to each of the one or more devices, which is identified by the acquired identifier information, from the relay servers excluding the first relay server, based on the stop request;
a generator configured to generate authentication information for each of the one or more devices to connect the one or more devices and the new connecting destination; and
a controller configured to control migration by transmitting a migration instruction and the authentication information to each of the one or more devices, the migration instruction providing an instruction for connection of the one or more devices to the new connecting destination.

10. The network control apparatus of claim 9, wherein the migration destination determination module is configured to determine the new connecting destination to equalize the number of devices connected to the relay servers.
